(19) United States
(12) Patent Application Publication
(10) Pub. No.: US 2011/0041660 A1
(43) Pub. Date: Feb. 24, 2011

(54) MONITORING UNIT FOR A MONITORING RANGE IN A MACHINE TOOL

(76) Inventors: Jochen Wingbermuehle, Hemmingen (DE); Matthias Heiler, Zurich (CH)

Correspondence Address: KENYON & KENYON LLP, ONE BROADWAY, NEW YORK, NY, 10004, US

(21) Appl. No.: 12/747,849

(22) PCT Filed: Oct. 31, 2008
(86) PCT No.: PCT/EP08/64803

§ 371 Date: Nov. 5, 2010

(30) Foreign Application Priority Data
Dec. 21, 2007 (DE) 102007062949.6

(51) Int. Cl. B23Q 17/24; B23Q 11/00; B26D 7/22; F16P 3/00

(52) U.S. Cl. 83/13; 83/58

(57) ABSTRACT

A machine tool device having a monitoring unit for monitoring at least one machine tool monitoring range, which has a projection unit for projecting into the machine tool monitoring range, a detection unit for detecting the machine tool monitoring range, and a pattern generation unit for generating at least one pattern for projection into the machine tool monitoring range. The machine tool device has an evaluation unit which is provided for evaluating a pattern which is associated with the generated pattern and detected with the aid of the detection unit.

### FIELD OF THE INVENTION

The present invention is directed to a machine tool device having a monitoring unit for monitoring at least one machine tool monitoring range.

### BACKGROUND INFORMATION

A sawing machine apparatus for monitoring a hazard range for a sawing machine in the immediate proximity of a saw blade is known which has a video camera and a projection unit for projecting a pattern onto a work surface of the sawing machine.

### SUMMARY

The present invention is directed to a machine tool device having a monitoring unit for monitoring at least one machine tool monitoring range, and including a projection unit for projecting into the monitoring range, a detection unit for detecting the machine tool monitoring range, and a pattern generation unit which is provided for generating at least one pattern for projection into the machine tool monitoring range.

The machine tool device has an evaluation unit which is provided for evaluating a pattern which is associated with the generated pattern and detected with the aid of the detection unit. A monitoring operation for the machine tool monitoring range may thus be carried out in which high reliability in monitoring various environmental parameters, such as lighting conditions, for example, and very different types of objects to be monitored may be achieved. If the machine tool monitoring range is to be monitored in particular for the presence of a human body part, it is possible to greatly reduce an influence of skin color, clothing, or shape or a position of the body part on a monitoring operation. The evaluation unit in particular has a computing unit which is provided for evaluating at least one geometric feature of the detected pattern, thus allowing short evaluation times to be achieved. The presence of an object in the machine tool monitoring range may be identified in a particularly simple manner by having the computing unit evaluate geometric features of the detected pattern brought about by projecting the generated pattern onto the object. The evaluation unit may have a memory unit in which a program, executed by the computing unit for evaluating the detected pattern, is stored. The program may be an image processing program.

The projection unit and the pattern generation unit may have different designs, or together may have at least a partially one-piece design. The pattern generation unit may be designed as a computing unit which executes a program for generating the pattern. A “pattern” refers in particular to a geometric shape such as a geometric motif. For “detecting” the machine tool monitoring range, the detection unit has a field of vision, specified in particular by a lens, which includes at least the machine tool monitoring range or corresponds to the machine tool monitoring range. The term “provided” is understood in particular to mean “designed,” “equipped,” and/or “programmed.”

In one preferred embodiment of the present invention, the evaluation unit has a computing unit which is provided for examining the detected pattern for a predetermined feature, thus allowing particularly short evaluation times to be achieved. For this purpose the evaluation unit in particular has a memory unit in which data associated with the predetermined feature are stored. The feature is “predetermined” in particular by the fact that these data are present prior to an evaluation operation in the evaluation unit. The predetermined feature preferably corresponds to a feature which is characteristic of a given application situation which may potentially arise during use of a machine tool. The feature is used in particular for characterizing the presence of a workpiece to be machined and/or a human body part in the machine tool monitoring range.

The projection unit is advantageously provided for projecting the generated pattern with the aid of visible light. The projected pattern may thus also be advantageously used as a marker for at least one partial range of the machine tool monitoring range to be monitored. The projection unit preferably has a lighting arrangement for emitting light in a visible range. Projection with the aid of an invisible signal, such as in an infrared range, for example, is also possible.

The machine tool monitoring range advantageously has at least one hazard range situated in the immediate proximity of a tool, thus allowing a high level of safety to be achieved. The evaluation unit is designed in particular to recognize the presence of a human body part in the hazard range.

Safety may be further increased when the generated pattern is used for marking a hazard range in the immediate proximity of a tool. In particular, the projected pattern may mark at least one boundary of the hazard range. A range situated “in the immediate proximity” of a tool is understood in particular to mean a range composed of points having a minimum distance of less than 10 cm maximum, advantageously less than 5 cm, and preferably less than 2 cm from the tool.

The generated pattern advantageously has at least one continuous line, and the evaluation unit includes a computing unit which is provided for examining the detected pattern for at least one discontinuity, thus allowing a particularly rapid evaluation operation to be carried out. In particular, a height difference resulting from the presence of an object in the machine tool monitoring range may thus be evaluated in a particularly effective manner.

In addition, the generated pattern may have at least one line, and the evaluation unit may include a computing unit which is provided for examining the curvature of a line in the detected pattern associated with the generated line. This allows the presence of an object having a curved surface to be recognized in the machine tool monitoring range in a particularly simple manner. If the line in the generated pattern is a straight line, the computing unit is provided in particular for examining the line associated with the generated line for a deviation from linearity.

In a further embodiment of the present invention it is proposed that the generated pattern has at least two parallel lines, and the evaluation unit includes a computing unit which is provided for examining the parallelism of the lines in the detected pattern associated with the generated lines, thus allowing a particularly reliable monitoring operation to be achieved.

A particularly high information density and therefore a high level of differentiation may be achieved when the generated pattern is a grid pattern.

Moreover, it is proposed that the generated pattern has at least one curved line. In this manner a pattern may be achieved which is adapted to a workpiece having a curved surface, thus allowing a high level of differentiation to be achieved when such a workpiece is used.

In one preferred embodiment of the present invention, the machine tool device has a safety device which is provided for carrying out a safety measure as a function of a signal of the evaluation unit. Such cooperation of the evaluation unit and a safety device allows particularly short response times to be achieved in recognizing a hazard situation during use of a machine tool. The safety device in particular has at least one actuator unit which is used for carrying out a safety measure relating to a tool, and a control unit which is provided for activating the actuator unit as a function of a signal of the evaluation unit. The actuator unit may be used to stop a drive of the tool, for example in cooperation with a securing arrangement and/or a drive unit, and/or may be used for moving the tool into a range that is inaccessible to a user, and/or may be designed to cover the tool.

In this regard it is proposed that the evaluation unit has a computing unit which is provided for associating a safety level of the safety device with a feature of the detected pattern. In this manner a safety measure may be carried out particularly quickly after a hazard situation arises. A “safety level” refers in particular to an identifier for a given safety mode. In a low safety level, a first safety mode may be used to continue driving the tool. At least one second, high safety level is advantageously provided which corresponds to a second safety mode in which a safety measure is carried out by the actuator unit and/or the control unit. The safety levels may in particular be prestored in a memory unit which is operatively linked to the computing unit.

Moreover, the present invention is directed to a method which includes a machine tool device and which is used to monitor a machine tool monitoring range of a machine tool, in which a pattern is generated and is projected into the machine tool monitoring range.

It is proposed that a detected pattern associated with the generated pattern is evaluated. A monitoring operation for the machine tool monitoring range may thus be carried out in which high reliability in monitoring various environmental parameters, such as lighting conditions, for example, and very different types of objects to be monitored may be achieved.

In addition, it is proposed that a safety level of a safety device is associated with a feature of the detected pattern and is used to carry out a safety measure, thus allowing particularly short response times to an existing and/or imminent hazard.

### BRIEF DESCRIPTION OF THE DRAWINGS

The figures illustrate exemplary embodiments of the present invention. The figures and description below contain numerous features in combination. One skilled in the art will advantageously also consider the features individually and combine them to form further practical combinations.

FIG. 1 shows a sawing machine having a work surface, a saw blade, and a monitoring unit.

FIG. 2 shows an internal circuit of the sawing machine having the saw blade, the monitoring unit which includes a video camera and a projection unit for projecting a pattern, and an evaluation unit.

FIG. 3 shows a pattern detected by the video camera.

FIG. 4 shows the sawing machine during the machining of a workpiece, a pattern being projected onto the work surface and the workpiece.

FIG. 5 shows a pattern having a discontinuity detected by the video camera, for the application situation from FIG. 4.

FIG. 6 shows the sawing machine with a user's hand located in a hazard range.

FIG. 7 shows a pattern having curved ranges detected by the video camera, for the application situation from FIG. 6.

FIG. 8 shows a grid-shaped pattern.

FIG. 9 shows a pattern associated with the grid pattern and detected by the video camera.

FIG. 10 shows a pattern having curved lines.

### DETAILED DESCRIPTION OF EXAMPLE EMBODIMENTS

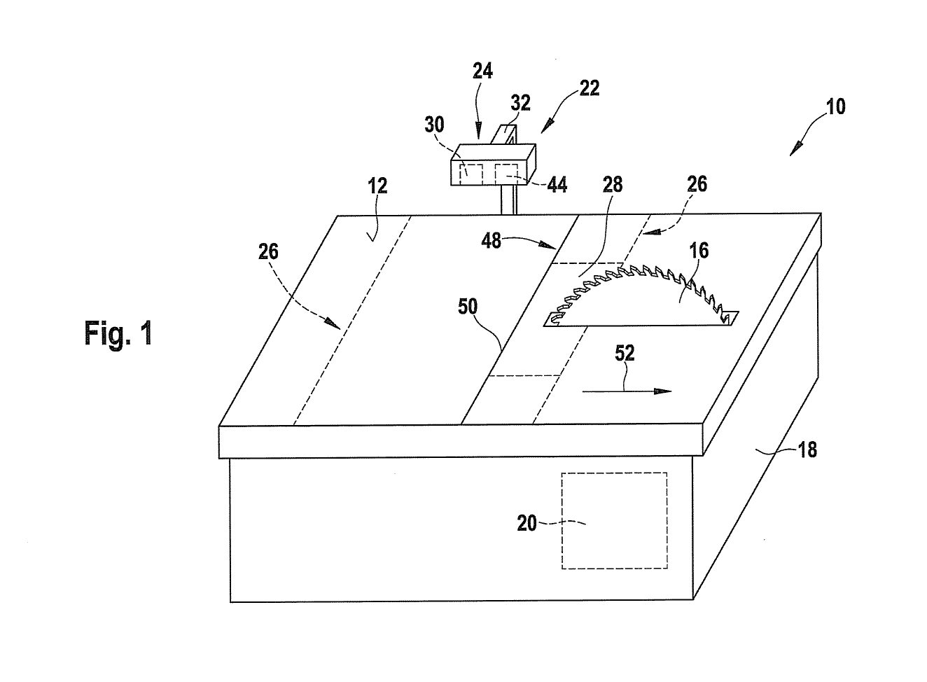

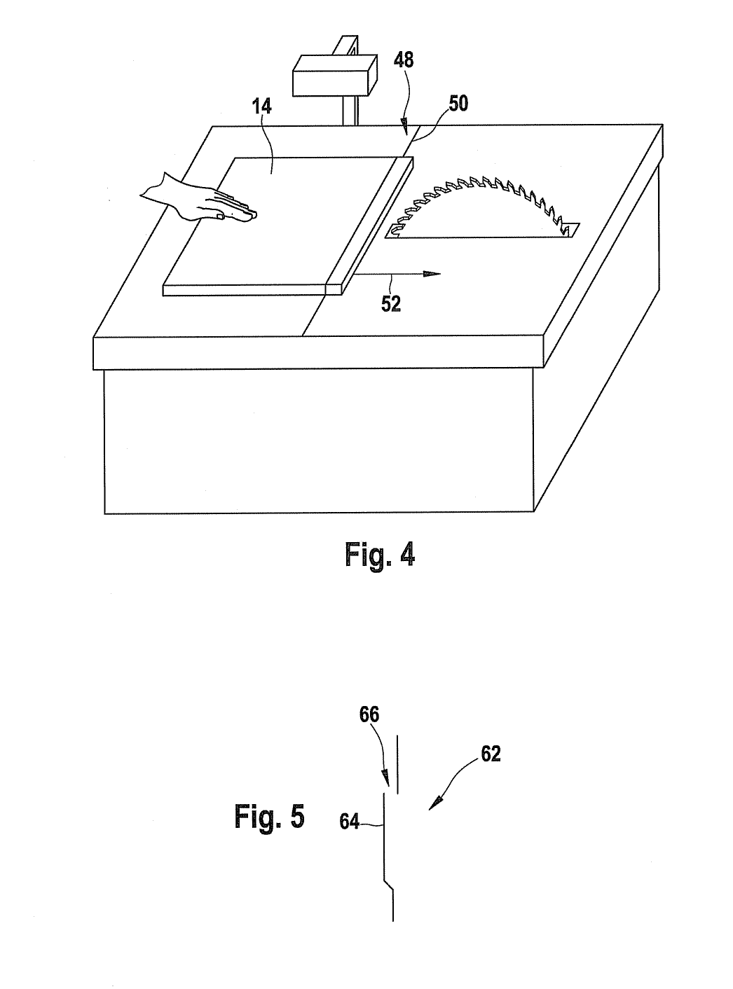

FIG. 1 shows a machine tool 10 designed as a circular table saw, in a perspective view. The machine tool has a work surface 12 which is designed as a workpiece support surface for laying a workpiece 14 to be machined (see FIG. 4), and which is horizontally oriented in a base mounting position of machine tool 10. A tool 16 designed as a circular saw blade projects from work surface 12. In a workpiece machining operation, tool 16 is set in rotation by a drive unit 20 which is located in a drive housing 18 situated beneath work surface 12 and which is designed as an electric motor.

Machine tool 10 includes a machine tool device 22 having a monitoring unit 24. This monitoring unit 24 is provided for monitoring a machine tool monitoring range 26. The boundary of machine tool monitoring range 26 on work surface 12 is schematically illustrated by dashed lines in FIG. 1. Machine tool monitoring range 26 contains a partial range of work surface 12, and also extends vertically upward starting from work surface 12. Machine tool monitoring range 26 has a partial range situated in the range of tool 16. This partial range, referred to as hazard range 28, is in the immediate proximity of tool 16. In particular, hazard range 28 directly adjoins tool 16. This hazard range 28 represents a range in which intrusion of a body part of an operator of machine tool 10 is to be avoided. Monitoring unit 24 has a detection unit 30, designed as an imaging unit, which is used to detect machine tool monitoring range 26. For this purpose, detection unit 30 has a field of vision corresponding to machine tool monitoring range 26 to be monitored. In the exemplary embodiment shown, detection unit 30 is situated in a position over work surface 12. Machine tool device 22 has a retaining device 32 which is provided for holding detection unit 30 in this position. Additional configurations of detection unit 30 relative to work surface 12 are possible which are meaningful to one skilled in the art.

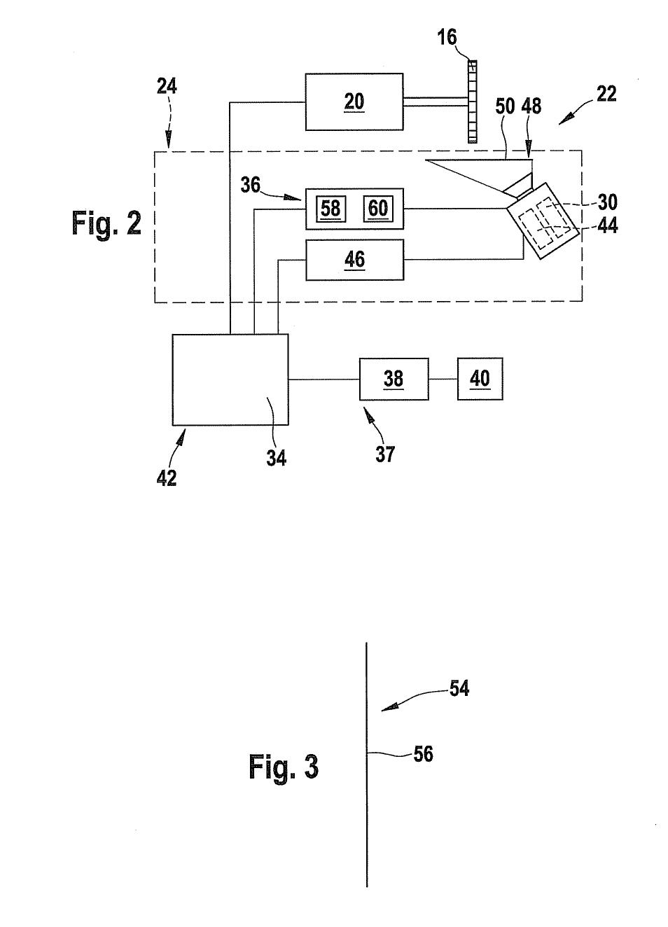

FIG. 2 schematically illustrates an internal circuit of machine tool 10. Machine tool device 22 has a control unit 34 which is provided for carrying out operating modes of machine tool 10. Control unit 34 has internal functional elements (not illustrated in greater detail), for example a computing unit, memory unit, etc., which are used for executing operating programs. Control unit 34 is operatively linked to drive unit 20, and is able to transmit control signals to drive unit 20 for controlling and/or regulating a drive of tool 16. In addition to detection unit 30 described above, monitoring unit 24 has an evaluation unit 36 which is operatively linked to detection unit 30 and to control unit 34, and whose function is described in greater detail below. Evaluation unit 36 and control unit 34 together may have at least a partially one-piece design.

Machine tool device 22 also has a safety device 37 which is used to carry out safety measures for an operation of machine tool 10. For this purpose, safety device 37 has an actuator unit 38 which is designed to carry out safety measures which relate to tool 16. According to these safety measures, this tool must be, for example, stopped or moved to a range that is inaccessible to the operator when there is risk of injury to the operator. Actuator unit 38 is used to trigger a securing arrangement 40 operatively linked thereto. In a first alternative, securing arrangement 40 is designed to stop the motion of tool 16 when triggered by actuator unit 38. Securing arrangement 40 is designed as a clamping arrangement or a braking arrangement, for example. In another variant, securing arrangement 40 is designed to lower tool 16 into a range of drive housing 18 beneath work surface 12, which is inaccessible to the operator, when triggered by actuator unit 38. In another embodiment, the securing arrangement may be designed as a covering arrangement for covering tool 16. Securing arrangement 40 is triggered by actuator unit 38 when the actuator unit receives an actuating signal of control unit 34. Control unit 34 outputs this actuating signal to actuator unit 38 as a function of a signal of evaluation unit 36. As an alternative or in addition to actuator unit 38, an actuator unit 42 of machine tool device 22 is provided which corresponds to control unit 34. Actuator unit 42, designed as control unit 34, transmits a control signal to drive unit 20 as a function of a signal of evaluation unit 36, thus stopping the drive of tool 16. Thus, a safety measure is carried out by actuator unit 38 and/or 42 as a function of a signal of evaluation unit 36 which triggers activation of actuator unit 38 or 42 by control unit 34. The signal of evaluation unit 36 is transmitted to control unit 34 when a hazard situation is recognized for a drive of tool 16 with the aid of an evaluation operation based on data, in particular image data, detected by detection unit 30. This recognition process is described in greater detail below.

Monitoring unit 24 has a projection unit 44 which is provided for projecting into machine tool monitoring range 26. Monitoring unit 24 also includes a pattern generation unit 46 which is used for generating a pattern for projection by projection unit 44 into machine tool monitoring range 26. Pattern generation unit 46 is operatively linked to control unit 34 and to projection unit 44. The pattern generation unit may also be a component of evaluation unit 36 and/or of control unit 34, or may have a design identical to evaluation unit 36 or to control unit 34. Pattern generation unit 46 in particular has a program, such as an image processing program, for example, which is provided for generating a pattern and which is stored in a memory unit, not illustrated in greater detail. As shown in FIGS. 1 and 2, pattern generation unit 46 generates a pattern 48, having a continuous straight line 50, which is projected onto work surface 12. In its projected state, line 50 is perpendicular to a preferred working direction 52 in which workpiece 14 is brought against driven tool 16 (also see FIG. 4). It is particularly advantageous when pattern 48 marks hazard range 28. As shown in FIG. 1, line 50 coincides with an outer boundary of hazard range 28. Thus, pattern 48 represents an optical boundary which is not to be crossed by a user. It is therefore advantageous when projection unit 44 is provided for projection in the visible range. Detection unit 30 in particular is designed as a video camera which is provided for detecting in the visible range. Projection and detection in an invisible range, for example in an infrared range, is possible. Projected pattern 48 is detected by detection unit 30 which is designed as a video camera. In the situation illustrated in FIG. 1, work surface 12 is free of objects. A pattern 54 brought about in this situation by generated pattern 48 and detected by detection unit 30 is illustrated in FIG. 3. Since generated pattern 48 is projected onto a flat surface, detected pattern 54 corresponds to generated pattern 48; i.e., detected pattern 54 likewise has a continuous straight line 56.

According to an example embodiment of the present invention, evaluation unit 36 is provided for evaluating a pattern brought about by a generated pattern, such as pattern 48, for example, which is detected by detection unit 30. For this purpose, evaluation unit 36 is provided with a computing unit 58 which is used for examining the detected pattern for at least one geometric feature. Computing unit 58 may have a microprocessor or may be designed as a microprocessor. The computing unit examines the detected pattern with the aid of a program, in particular an image processing program, stored in a memory unit 60 of evaluation unit 36. In the present case, computing unit 58 detects that detected pattern 54 corresponds to a straight line 56. In addition, reference data which are used in the evaluation of detected pattern 54 are prestored in memory unit 60. These reference data correspond to pattern features which in each case are characteristic of a predetermined, typical application situation of machine tool 10, and which are associated with a particular safety level of safety device 37. By use of these data, computing unit 58 associates the application situation in FIG. 1 and a low safety level with detected pattern 54 as a straight line, according to which tool 16 continues to be driven.

It is assumed that a user of machine tool 10 places workpiece 14 on work surface 12. This is illustrated in FIG. 4. A hand of the user which is placed on workpiece 14 and which guides workpiece 14 in working direction 52 is schematically illustrated. As a result of the position of workpiece 14 in the field of projection of projection unit 44, a pattern 62 detected by detection unit 30 deviates from pattern 48 generated by pattern generation unit 46. Detected pattern 62, illustrated in FIG. 5, has the shape of a straight line from which a middle line 64 is offset from the remaining end ranges of the straight line, line 64 corresponding to the projection of generated pattern 48 onto the surface of workpiece 14, and the end ranges corresponding to the projection of pattern 48 onto work surface 12. The offset of middle line 64 results in a discontinuity 66 in pattern 62. Computing unit 58 is provided in particular for examining detected pattern 62 for at least one discontinuity. Depending on the configuration and/or number of discontinuities, various application situations of machine tool 10 may be inferred. By using reference data prestored in memory unit 60, features, in particular with regard to the presence of discontinuity 66, are recognized as features which are characteristic of an application situation, in particular the application situation illustrated in FIG. 4. In the present case, the low safety level is associated with evaluated pattern 62, according to which tool 16 continues to be driven.

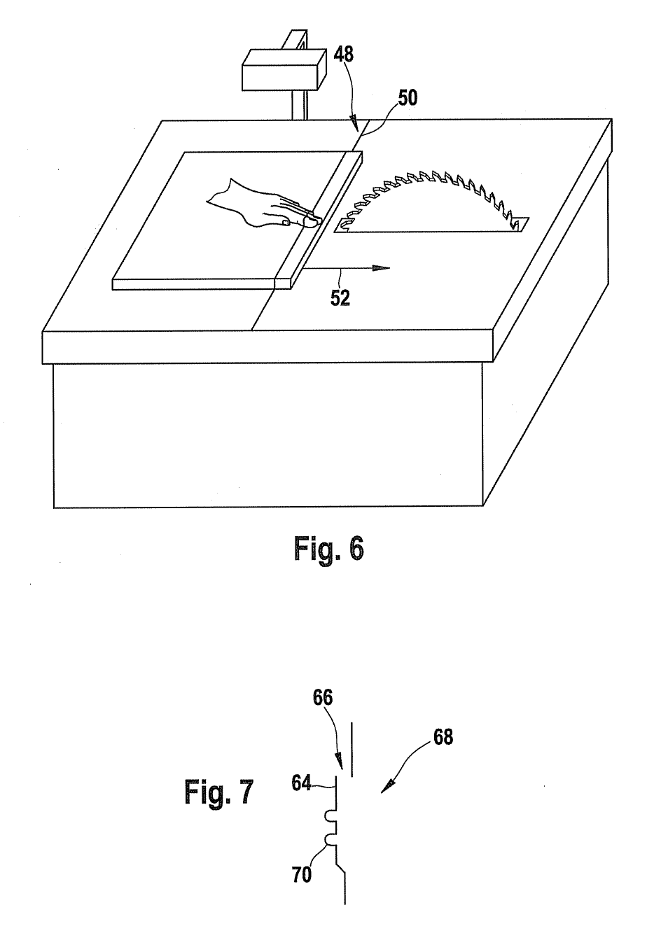

A further application situation is illustrated in FIG. 6, in which a hand of the user passes into hazard range 28 (see FIG. 1). Detected pattern 68 detected by detection unit 30 in this application situation is illustrated in FIG. 7. In addition to the features present in FIG. 5, pattern 68 has curved ranges in the form of rounded areas 70 of line 64 which are caused by the projection of generated pattern 48 onto the user's fingers which have passed into hazard range 28. Computing unit 58 is provided in particular for examining a detected pattern for the curvature of lines. Depending on the configuration and/or number of curved ranges, various application situations of machine tool 10 may be inferred. In the present case, rounded areas 70 are registered by computing unit 58. By use of reference data in memory unit 60, a high safety level of safety device 37 is associated with this feature of detected pattern 68, according to which the drive of tool 16 is stopped and/or tool 16 is lowered beneath work surface 12. Evaluation unit 36 transmits a signal to control unit 34, which initiates the above-described safety measures with the aid of actuator unit 38 and/or 42.

The number of characteristic features prestored in memory unit 60 is limited. If it is not possible to associate a feature of the detected pattern with any of the prestored features in memory unit 60, in order to achieve a high level of safety, this feature is automatically associated with the high safety level. In this manner this safety level is associated with this feature of the detected pattern without a predetermined application situation being recognized. As a result of this number of predetermined application situations which are known to evaluation unit 36, embodiments of evaluation unit 36 may differ. In one simple variant it is possible to store in memory unit 60 only data of characteristic features which correspond to common application situations which are associated with the low safety level, such as the application situations illustrated in FIGS. 1 and 4 in particular. If features of the detected pattern are recognized as typical features of one of these application situations by use of these data, the workpiece machining operation is continued. Safety measures are initiated in all other cases which are not individually recognized. This variant is particularly advantageous for machining common workpieces having a simple geometry, such as planar pieces of wood, for example. In another variant it is possible to store a database in memory unit 60 which alternatively or additionally allows application situations for which safety measures are to be initiated to be individually recognized by computing unit 58. This database may be generated, for example, in the production plant and/or with the aid of a self-learning mode of evaluation unit 36.

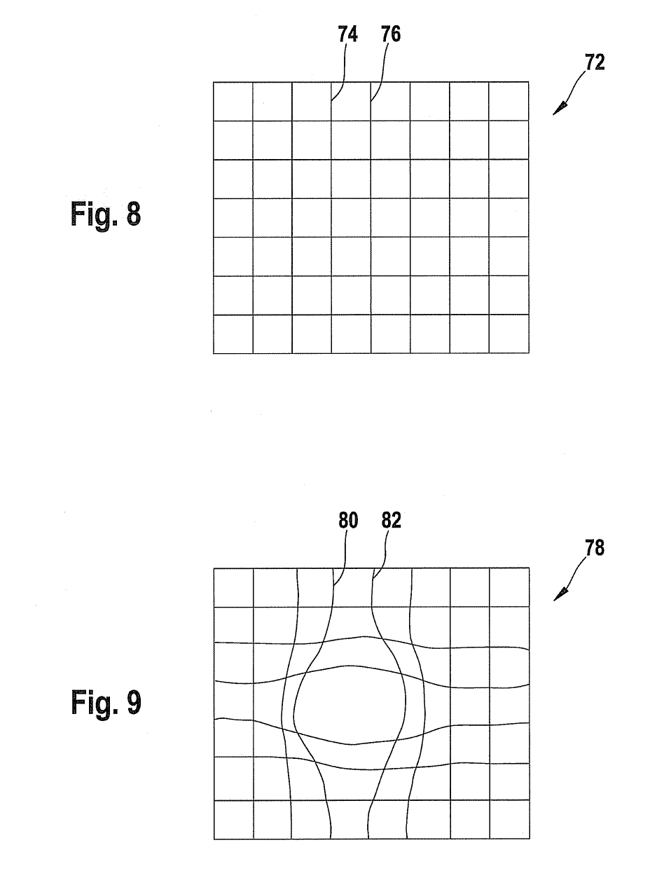

Further embodiments of a generated pattern are possible. FIG. 8 shows a generated pattern 72 designed as a grid pattern. Pattern 72 in particular has two parallel lines 74, 76. A pattern 78 detected by detection unit 30 is illustrated in FIG. 9. As described above, computing unit 58 is able to examine lines 80, 82, which correspond to lines 74, 76, respectively, of generated pattern 72 for the presence of at least one discontinuity and/or examine the curvature of one of lines 80, 82. Computing unit 58 is also provided for examining the parallelism of lines 80, 82. In particular in the present case of a planar workpiece 14, a safety level such as the high safety level, for example, may be associated with the feature of a nonparallelism of lines 80, 82 which is caused in particular, for example, by the projection of pattern 72 onto the back of the hand or an arm of the user.

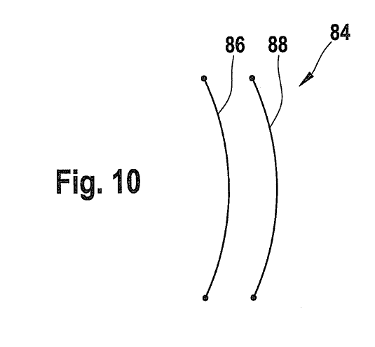

In a further embodiment variant illustrated in FIG. 10, pattern generation unit 46 generates a pattern 84 having curved lines 86, 88. This is particularly advantageous for machining a workpiece having a convex surface. In this manner, for example, the curvature of the workpiece surface may be compensated for by a curvature of generated pattern 84, so that pattern 84 projected onto the workpiece surface is designed as a linear pattern. Lines 86, 88 are aligned in parallel. As described above, computing unit 58 is able to examine the parallelism of lines of a detected pattern which are associated with lines 86, 88 in pattern 84.

In one embodiment variant, machine tool device 22 may have an input unit which is associated with monitoring unit 24, with the aid of which a user may make a selection regarding a pattern to be projected. The user may also use the input unit to design a pattern to be projected which is adapted to a workpiece to be machined. Machine tool device 22 is also suited for other types of machine tools, for example compound miter saws, miter saws, band saws, etc.

1-13. (canceled)

14. A machine tool device, comprising:
a monitoring unit to monitor at least one machine tool monitoring range;
a projection unit to project into the machine tool monitoring range;
a detection unit to detect the machine tool monitoring range;
a pattern generation unit to generate at least one pattern for projection into the machine tool monitoring range; and
an evaluation unit to evaluate a pattern which is associated with the generated pattern and detected with the aid of the detection unit.

15. The machine tool device as recited in claim 14, wherein the evaluation unit includes a computing unit to examine the detected pattern for a predetermined feature.

16. The machine tool device as recited in claim 14, wherein the generated pattern is used for marking a hazard range in an immediate proximity of a tool.

17. The machine tool device as recited in claim 14, wherein the generated pattern has at least one continuous line, and the evaluation unit includes a computing unit which examines the detected pattern for at least one discontinuity.

18. The machine tool device as recited in claim 14, wherein the generated pattern has at least one line, and the evaluation unit has a computing unit to examine a curvature of a line in the detected pattern associated with the generated line.

19. The machine tool device as recited in claim 14, wherein the generated pattern has at least two parallel lines, and the evaluation unit includes a computing unit to examine a parallelism of lines in the detected pattern associated with the generated parallel lines.

20. The machine tool device as recited in claim 14, wherein the generated pattern is a grid pattern.

21. The machine tool device as recited in claim 14, wherein the generated pattern has at least one curved line.

22. The machine tool device as recited in claim 14, further comprising:
a safety device to carry out a safety measure as a function of a signal of the evaluation unit.

23. The machine tool device as recited in claim 22, wherein the evaluation unit includes a computing unit to associate a safety level of the safety device with a feature of the detected pattern.

24. A machine tool comprising:
a tool; and
a machine tool device including a monitoring unit to monitor at least one machine tool monitoring range associated with the tool. a projection unit to project into the machine tool monitoring range, a detection unit to detect the machine tool monitoring range, a pattern generation unit to generate at least one pattern for projection into the machine tool monitoring range, and an evaluation unit to evaluate a pattern which is associated with the generated pattern and detected with the aid of the detection unit.

25. A method, comprising:
monitoring a machine tool monitoring range of a machine tool;
generating and projecting a pattern into the machine tool monitoring range;
associating a detected pattern with the generated pattern; and
evaluating the detected pattern.

26. The method as recited in claim 25, further comprising:
associating a safety level of a safety device with a feature of the detected pattern; and
carrying out a safety measure using the safety level.
